(19) United States
(12) Patent Application Publication
(10) Pub. No.: US 2011/0292869 A1
(43) Pub. Date: Dec. 1, 2011

(54) SYSTEM AND METHOD FOR MONITORING AND CONTROL POWER

(76) Inventor: MARCUS KRIETER, Newport Beach, CA (US)

(21) Appl. No.: 12/790,297

(22) Filed: May 28, 2010

(51) Int. Cl. H04W 4/00; G06F 1/26

(52) U.S. Cl. 370/328; 713/310; 713/300

(57) ABSTRACT

An improved system for power monitoring and control is an aftermarket method for improving power monitoring and control in end-user environments such as offices and homes. The disclosed is a wirelessly connected panel that monitors and/or controls power passed through a power interface and is intrinsically paired with that interface. The system uses an ultra low power panel that is associated with its power interface. The system can be detached and located at a distant remote location. The radio link is used to maintain control automatically paired with the power interface connection it is physically associated with. The panel and system use a hopping meshed radio network to insure full range of coverage within a building.

### FIELD OF INVENTION

The present invention relates to power management, and more particularly, to monitoring and controlling power usage in a home, office or like environment.

### BACKGROUND

Electric power is a very important resource which plays a critical role in the growth of any country. Electric power is essential to develop industries and communities, and modern society cannot exist without it. Various household equipment such as televisions, computers, washing machine, kitchen appliances, and other electronic devices require power for operation. Needs of modern and luxury houses have led to the development of complex and complicated wiring systems. Offices and business places accommodate more complex wiring systems as compared to households. Emerging technologies and proliferation of new hi tech gadgets into our lives have increased the burden of electricity usage on worldwide.

In the context of the 21st century, controversial and urgent issues like global warming, and clean and green technologies have compelled the world to take such issues seriously in order to find practical and sustainable solutions. Much of the research surrounding these issues involve exploiting renewable energy such as solar and wind energy as an alternative source of energy.

In a typical home or office setting, it is common to find numerous electronic devices such as computers, computer peripherals, fax machines, audio visual and entertainment equipment, fans, lamps, coffee machines and other common electrical appliances and hardware that are independently interfaced to AC power. It is common for many of these devices to remain in powered-on positions inadvertently during periods of non-use.

There are many devices that provide remote monitoring and control of power interfaces through a variety of building installations or aftermarket means. However, all of these systems require complex installation and control schemes and are typically expensive to purchase.

Therefore, proper and effective usage of power is a primary and essential requirement for reducing the increasing electric consumption in homes and offices settings. In order to verify power use quickly or whether all the household appliances are switched off, an inexpensive, efficient, and user friendly system is disclosed to monitor and control the power passing through electric outlets, power expanders, or extension cords that supply or interrupt power to such appliances.

In light of the foregoing, there is a need of a simple system to control and monitor power in homes, offices and like places.

In order to solve the problem, the present invention provides a system for monitoring and/or controlling power in homes or offices. The power monitoring and control system is purchased and installed by an end-user in the same manner that they would buy and install an AC plug, expansion strip, plug adapter or extension cord. The disclosed power monitoring and control system operates in a similar fashion as a standard power strip, adapter or extension cord.

The power monitoring and control system may also be attached or coupled near an exit of the building where no installation may be required other than a simple placement of the system with tape, a magnet, bracket, or other such fixture means. Upon exiting the building, a party is given a quick means to verify that power in any connected devices was indeed switched off. Other similar uses would be in kitchens where appliances such as coffee makers, radios, fans, televisions or other appliances may also be easily inadvertently left powered-on. A key aspect of the power monitoring and control system is its cost effective and simplicity of installation and use by end-users.

### BRIEF SUMMARY OF THE INVENTION

An object of the present invention is to provide a cost effective, ultra low-power, and user friendly system for monitoring and/or controlling power interface devices, thereby supplying and interrupting power to electronics appliances connected to the power interface through outlets, power expanders, or extension cords or sockets.

Another object of the present invention is to provide an improved system for monitoring and/or controlling the power interface devices in end-user environments such as offices and homes.

Another object of the present invention is central monitoring and/or controlling the powered status as “on” or “off” of outlets of the power interface devices through a power monitoring and control system.

Yet another object of the present invention is to provide a system for quickly verifying the power in the outlets of the power interface devices.

In another embodiment, the present invention provides an electronic system for improving power management comprising: a display including a touch surface; a micro controller unit coupled to the display; a transceiver coupled to the micro controller unit; and a power means supplying power to a transceiver and the micro controller unit.

In another embodiment, the present invention provides a method of controlling and managing power delivery to an appliance, comprising the steps of: monitoring an electric current supplied to an appliance; transmitting an indication of the electric current to a remote display; and displaying on the remote display the indication of electric current.

In another embodiment, the present invention provides A system for controlling and managing power delivery to an appliance, comprising a display including a touch surface; a micro controller unit coupled to the display; a transceiver coupled to the micro controller unit; and a wireless ad hoc mesh network coupling the transceiver to a remote power interface.

Yet another object of the present invention is to provide a system that consumes ultra low-power with quick and simple installation and control scheme.

To achieve the objects of the present invention, an embodiment of the present invention comprises an electronic system for improving power management, a display including a touch surface, thereby allowing monitoring and controlling the activity of a plurality of power outlets of a power interface; a micro controller unit coupled to the display and the touch surface; a transceiver coupled to the micro controller unit; and a power means supplying power to the transceiver and the micro controller unit.

### BRIEF DESCRIPTION OF THE DRAWINGS

The preferred embodiments of the invention will hereinafter be described in conjunction with the figures provided herein to further illustrate various non-limiting embodiments of the invention, wherein like designations denote like elements, and in which:

FIG. 1A illustrates a perspective view of a power interface coupled to power monitoring and control panel, in accordance with an embodiment of the present invention.

FIG. 1B illustrates a 90 degree angled view of a power interface coupled to power monitoring and control panel, in accordance with an embodiment of the present invention.

FIG. 1C illustrates a side view of a power interface coupled to power monitoring and control panel, in accordance with an embodiment of the present invention.

FIG. 2A illustrates an exemplary nub on the top plane surface of a power interface for mechanical alignment with the power monitoring and control panel, in accordance with an embodiment of the present invention.

FIG. 2B illustrates an exemplary nub receptacle on the bottom surface of the power monitoring and control panel for mechanical alignment with the power interface, in accordance with an embodiment of the present invention.

FIG. 3 illustrates a perspective view of the power monitoring and control panel depicting the status of the AC power passed through each corresponding outlet of the power interface, in accordance with an embodiment of the present invention.

FIG. 4 illustrates a block diagram of an exemplary power interface coupled to the power monitor and control panel, in accordance with an embodiment of the present invention.

FIG. 5 illustrates a block diagram of an exemplary power monitoring and control panel, in accordance with an embodiment of the present invention.

FIG. 6 illustrates an exemplary view of a mesh network showing data connectivity, paring and range grouping between the power interfaces and the power monitoring and control panels, in accordance with an embodiment of the present invention.

### DETAILED DESCRIPTION OF THE EMBODIMENTS

In the following detailed description of the embodiments of the invention, numerous specific details are set forth in order to provide a thorough understanding of the embodiments of the invention. However, it will be obvious to one skilled in the art that the embodiments of the invention may be practiced without these specific details. In other instances well known methods, procedures, components, and circuits have not been described in detail so as not to unnecessarily obscure aspects of the embodiments of the invention.

Furthermore, it will be clear that the invention is not limited to these embodiments only. Numerous modifications, changes, variations, substitutions and equivalents will be apparent to those skilled in the art without parting from the spirit and scope of the invention.

The embodiments of the invention include a system to monitor and/or control the power passed through power interface devices and quickly verify if a power is being supplied to outlets of the power interface, power expanders, or power extension strip or cords that detect an inline current power outlets.

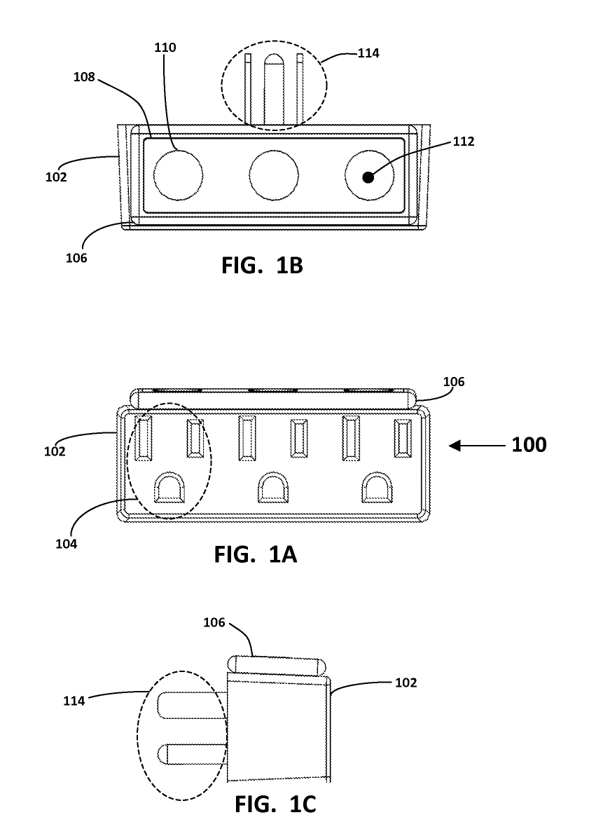

FIG. 1A illustrates a perspective view of a power interface coupled to power monitoring and control panel, in accordance with an embodiment of the present invention. FIG. 1A illustrates a power interface 102 having plurality of AC power outlet 104 and at least one AC power inlet 114 including a power monitoring and control panel 106 that can lie on top of the power interface 102 in accordance with an embodiment of the present invention. FIG. 1A illustrates a one to three expansion arrangement. In this embodiment, a power monitoring and control panel 106 is magnetically attached to the power interface expander 102. The power monitoring and control panel 106 monitors and/or controls the power passed through each of the power interface 102 outlets. In the preferred embodiment, the power monitoring and control panel 106 has an active display area 108 arranged into three regions 110 having a touch surface 112, such as a keypad, touch button, or touch screen surface. Each region 110 corresponds to a single AC power outlet 104 and displays the activity of a particular AC power outlet 104 or displays and controls the activity of its corresponding AC power 104 outlet. In the FIG. 1A the power monitoring and control panel 106 may be attached to the power interface 102 mechanically or magnetically.

Referring to FIG. 1B, FIG. 1B illustrates a 90 degree angled view of a power interface 102 coupled to power monitoring and control panel 106, in accordance with an embodiment of the present invention.

The AC power inlet 114 is used as a main source of supply of AC power to the power interface 106 through which various electronics appliances are connected. The active display area 108 of the panel 106 is divided into three regions 110. These regions 110 works as activity indicators showing the current status of the AC power outlet 104. These regions 110 can be used as control means like normal switches to interrupt the power supply through AC power outlet 104.

Referring to FIG. 1C, FIG. 1C illustrates a side view of a power interface 102 coupled to power monitoring and control panel 106, in accordance with an embodiment of the present invention.

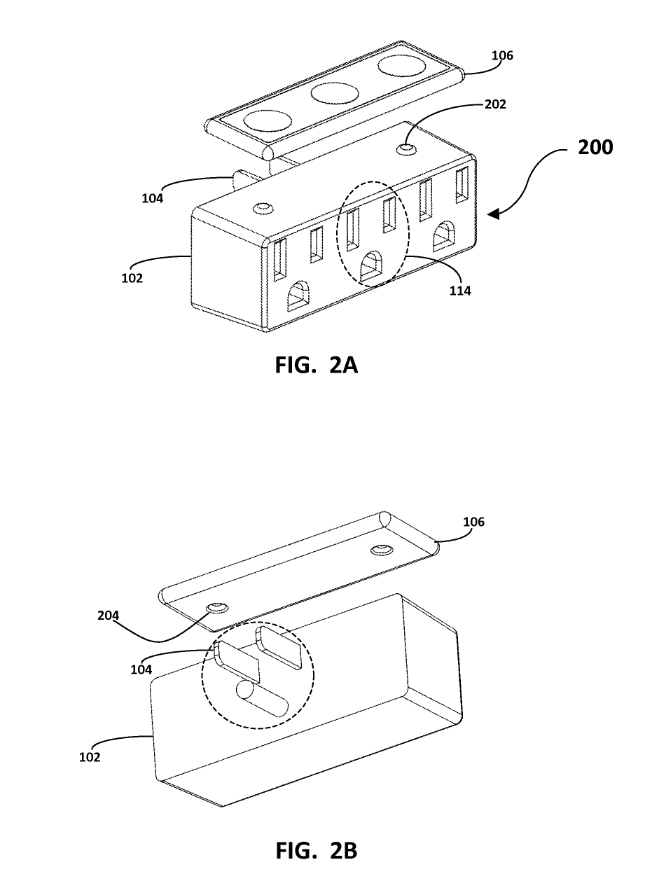

Referring to FIG. 2A-2B, FIG. 2A illustrates an exemplary nub 202 on the top plane surface of a power interface 102 for mechanical alignment with the power monitoring and control panel 106, in accordance with an embodiment of the present invention whereas FIG. 2B illustrates an exemplary nub receptacle 204 on the bottom surface of the power monitoring and control panel 106 for mechanical alignment with the power interface 102, in accordance with an embodiment of the present invention.

Referring to FIGS. 2A and 2B, the power monitoring and control panel 106 is separated from the power interface 102 expander and exposes alignment nubs 202 on the expander and nub receptacles 204 on the power monitoring and control panel 106. The nub receptacles 204 are used to hold the power monitoring and control panel 106 in mechanical alignment with the power interface 102 expander when they are mechanically coupled.

In an embodiment these features are simply mechanical. However, in other embodiments they may be electrically active and be used for additional functions such as alternate pairing of the power monitoring and control panels 106 to the power interface 102 expanders. The power monitoring and control panels 106 are charged when they are attached to the power interface 102.

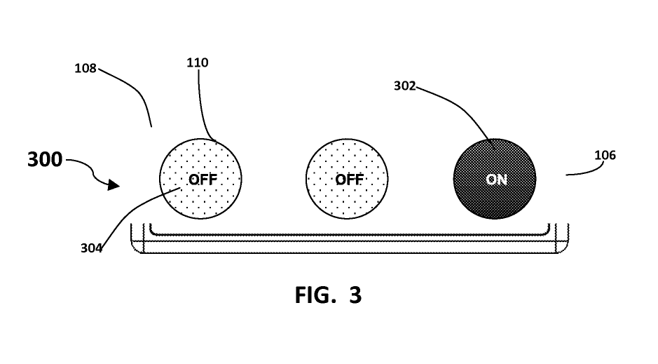

Referring to FIG. 3, FIG. 3 illustrates a perspective view of the power monitoring and control panel depicting the status of the AC power passing through each corresponding outlet of the power interface, in accordance with an embodiment of the present invention. FIG. 3 is a perspective view of the power monitoring and control panel 106 illustrating the status of the power passed through each corresponding outlet 104 of the power interface 102. FIG. 3 illustrates how the individual indicator regions 110 can be used to indicate power flow through each of the outlets 104 that correspond to their respective region 110. Outlets 104 supplying little or no current to their respective load are indicated by a transparent 304 or minimally opaque dot 304. Outlets 104 supplying current above a preset threshold are indicated by a heavily opaque dot 302. This power “on” or “off” indication can alternatively be replaced with a quantitative indication of the amount of power supplied per outlet 104 or some other derivative indication such as the cost per hour of operation for that outlet 104. In another embodiment, each opaque dot can have a customized label, such as “television”, “radio”, “computer”, etc. that corresponds to the appliance that is being monitored. The advantage of the power “on” or “off” qualitative indication is that it allows for very rapid assessment of the same status for devices connected to the respective outlet 104.

Through use of a touch sensitive surface, the indicator regions 110 could be given control over their respective outlet 104. In the embodiment shown in FIG. 3, each region 110 could act as a remote toggle switch that would interrupt or allow supply of power to their respective power interface expander outlet 104.

Many embodiments of the remote power monitoring and control panel 106 and the power interface 102 can be created using the basic method described. This includes extension cords, outlet or plug splitters, or terminal strips that have a length of power cable separating the power input connection from the monitored or monitored and controlled output section.

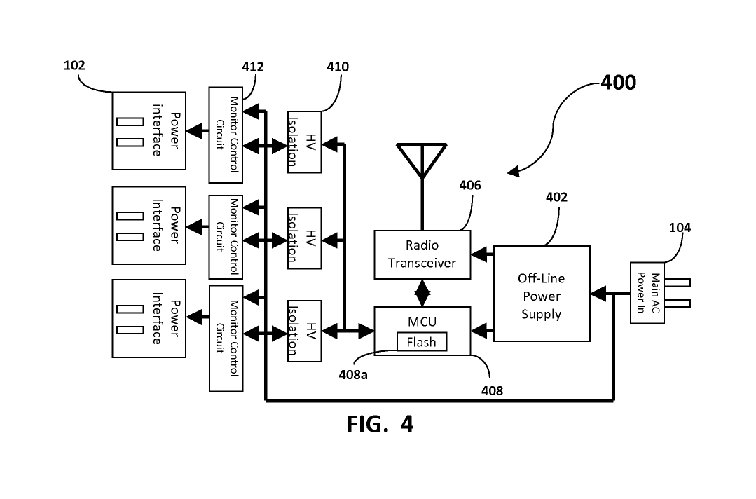

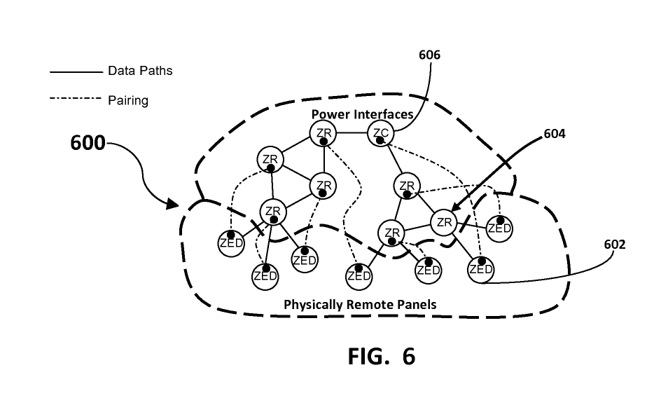

Referring to FIG. 4, FIG. 4 illustrates a block diagram of an exemplary power interface 102 coupled to the power monitor and control panel 106, in accordance with an embodiment of the present invention. FIG. 4 illustrates that a connection to the main AC power 104 is made with a high voltage isolated current 410 or an unisolated power conditioning and supply circuit. This arrangement provides a proper low voltage DC power amount to the micro controller unit MCU 408 and radio transceiver 406. The MCU 408 can be a simple microchip PIC type controller. It contains a resident flash memory 408a within a circuit that is programmable, and that contains data such as its unique factory programmed serial numbers and wireless network addresses and identification numbers of the panel 406 to which it is paired to. The MCU 408 also contains an application program that operates the system. This application includes a network communication stack such as IEEE 802.15.4. This stack is critical to the MCU's 408 ability to setup, control and maintain an ad-hoc mesh network connection as shown in FIG. 6, terminating with its associated panel 106 or other panels 106 as the protocol defines.

The MCU 408 also controls power switching of the main AC power 104 to enable power interface expander 102 and simultaneously measure whether or not a qualifying current is passing through an enabled power interface expander 102. This is accomplished by a monitor control circuit 412 for each power interface expander 102.

In each monitor control circuit 412, switching is implemented using an industry standard triac circuit that is controlled by a signal sourced from the MCU 408. An inline current sensing element, such as a low-value resistor, is used to measure current flowing through the power interface expander outlet 114. The current value is an analog value that is reported to the MCU 408. The MCU 408 uses either a resident analog comparator or resident analog-to-digital convertor to determine qualified values that merit control or reporting responses. Both the triac control input signal and the current value analog outputs are isolated from the main AC power for safety reasons.

The circuit presented uses optical isolation implemented with industry-standard high voltage optical isolators. In an alternate embodiment, magnetic or capacitive electrical isolation means may also be employed.

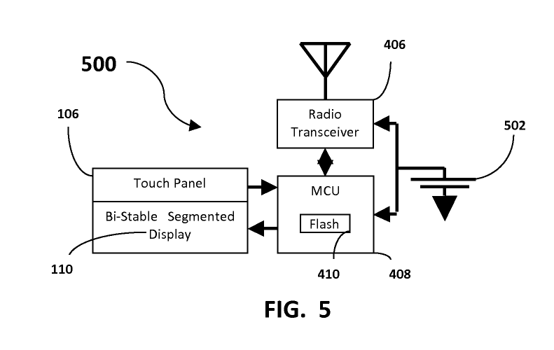

Referring to FIG. 5, FIG. 5 illustrates a block diagram of an exemplary power monitoring and control panel 106, in accordance with an embodiment of the present invention. A critical feature of this panel 106 is its extremely low power consumption. The panel 106 can be a display-only device or, alternatively as shown in FIG. 3, can be a display and control device. The system can be powered from a single coin cell 502 that is replaceable.

Alternatively, the power source can be augmented or replaced with a solar or other coupled power means that would charge a resident battery 502 or power store capacitor 502. In FIG. 5, the battery 502 powers the MCU 408. As with the power interface 102, the MCU 408 is a low-power version of a microchip PIC type controller. It contains resident flash memory 408a that stores unique data including its own factory programmed serial number and its unique wireless network address. The MCU 408 also contains an application program that operates the power monitoring and control panel system 106. This application includes a network communication stack such as IEEE 802.15.4. This stack is integral in the MCU 408's ability to setup, control and maintain an ad-hoc mesh network, as shown in FIG. 6, with the connection terminating with its associated power monitoring and control panel 106 or any such panels 106 that are required by the dynamic network topology.

Because of the low power budget required to operate for extended periods without a battery 502 change, the power monitoring and control panels 106 are designed to be endpoint devices 602.

In case of using IEEE 802.15.4, endpoints 602 would also use beaconing to further enhance their low power profile. To further reduce power, the indicator display 108 is a segmented bi-stable device that requires no power to maintain its image. An example of such a display 108 could employ e-ink technology. A simple contact touch-surface with discrete mechanical zones is used to avoid the power overhead needed to detect and resolve actuation positions on an analog touch surface.

The power monitoring and control panel 106 requires that the panels 106 are consuming very low power to avoid having to change batteries 502 frequently. The panels 106 are intended to be somewhat permanently installed so long battery life is critical to the overall user experience. However, the coverage of the panels 106 may involve entire facilities. Simple long range, point-to-point wireless connectivity is contra-indicated because of the power required to communicate wirelessly over extended distances.

A wireless mesh network topology is best suited for this type of application. IEEE 802.15.4 defines such topology and is suitable for the exemplary embodiment. Within the IEEE 802.15.4 standard, there are three basic device types. They are a IEEE 802.15.4 Coordinator (ZC) 606, IEEE 802.15.4 Repeater (ZR) 604 and IEEE 802.15.4 End Device (ZED) 602. A topological example network using these devices including their logical data connectivity, programmed pairing, and range grouping is illustrated in FIG. 6.

Because of the comparatively substantial power availability and intrinsically renewed AC power source, in comparison to the panel 106, power interface devices 102 are configured as IEEE 802.15.4 Repeaters 604 or IEEE 802.15.4 Coordinators 606. In a typical facility, one coordinator 606 and any number of repeaters 604 would be viable. The power monitoring and control panels 106 are exclusively configured as endpoints 602 as these are architecturally the lowest power devices.

Additionally, to save power, endpoints 602 would be configured to respond to a IEEE 802.15.4 beacon. This beacon would allow ZEDs 602 to remain in an “off” state for extended periods and only wake at predefined, low duty cycle receive intervals. These features, along with network setup, network control, and data routing are intrinsic to IEEE 802.15.4 and other low power wireless mesh networks. Hence, alternate standards or custom network protocols other than IEEE 802.15.4 could be used.

The power interface devices 102 acting as repeaters 604, and the coordinator 606 transact control and measurement information to the panels 106. In cases where the panels 106 may be physically too far from their paired power interface 102 to communicate directly, other power interfaces 102 will act as intermediary network nodes that repeat, or otherwise pass on, data to the destination panel 106 using data packet hops. In cases where a power interface 102 or a group of power interfaces 106 is too far from another to join the mesh, another power interface 102 may be added at a physical location that allows it to repeat data amongst disjointed nodes, thereby completing the mesh. This power interface 102 would not need to be paired with a panel 106 if that were its only purpose.

A key aspect of the system is its simplicity of installation and use. The panels 106 are paired with the power interfaces 102 that they are sold with. These panels 106 may also be re-paired with other power interfaces 102 simply by touching or connecting them briefly to the interface.

These panels 106 and power interface 102 pairs would work in a logically autonomously fashion from other displays and interface pairs other than that one of both of the paired items may act as wireless network relay nodes to other wireless power monitoring and control system network nodes.

The control or monitoring features are physically part of the system such as those that would be found on a power strip or socket expansion. However, these features can be removed and mounted separately from the unit at a remote location or substantial distance.

The power monitoring and control system is an aftermarket method to improve power monitoring and control in end-user environments such as offices and homes. The power monitoring and control system is a wirelessly connected panel 106 that monitors and/or controls power passed through a power interface 106 such as an AC socket expander or extension cord and is intrinsically (lying within a given part) paired with that interface. The power monitoring and control system uses an ultra low power panel 106 that is associated with its power interface 102. The power monitoring and control system serves as an activity indicator or control point similar to switches and LED or neon indicators that are currently used on common AC power strips. However, unlike these control and indicator features, the power monitoring and control system panel can be detached and located at a distant remote location.

An exemplary use for a power monitoring and control system may be in an isolated room that has several classes or types of electronic equipment such as a portable fan, lamp, computer, and computer peripherals. These devices may be accessed by numerous individuals and the room could be a secluded area, such as a basement or utility closer, that is not readily accessed by a person exiting the facility. Hence, it would be reasonable to assume that some or all devices may be left inadvertently on for extended periods of non-use when all of the occupants inside of the facility were gone. To improve power management in this case, a power monitor and control system or a plurality of power monitoring and control system devices could be used to interface each electronic piece of equipment to the facility power.

The invention has been described using example of a panel 106 as the power monitoring and control system. However, a person skilled in the art can easily understand that the described power monitoring and control system can be used for various other purposes. Therefore, objects and embodiments of the invention should be construed according to the claims that follow below.

While the principles of the disclosure have been illustrated in relation to the exemplary embodiments shown herein, the principles of the disclosure are not limited thereto and include any modification, variation or permutation thereof.

What is claimed is:

1. An electronic system for improving power management comprising:
a display including a touch surface;
a micro controller unit coupled to the display;
a transceiver coupled to the micro controller unit; and
a power means supplying power to a transceiver and the micro controller unit.

2. The electronic system of claim 1, wherein the display comprises a viewable area arranged into a plurality of regions.

3. The electronic system of claim 2, wherein each of the plurality of regions displays corresponds to a plurality of power consuming devices, respectively.

4. The electronic system of claim 2, wherein the display is an e-ink device.

5. The electronic system of claim 2, wherein the display is a bi-stable segmented display

6. The electronic system of claim 1, wherein the display indicates an inline current flow through each outlet corresponding to a power consuming device.

7. The electronic system of claim 1, wherein the touch surface is configured to receive input to control the inline current flow through each outlet corresponding to a power consuming device.

8. The electronic system of claim 1, wherein the display is mounted to a power interface mechanically or magnetically.

9. A method of controlling and managing power delivery to an appliance, comprising the steps of:
monitoring an electric current supplied to an appliance;
transmitting an indication of the electric current to a remote display; and
displaying on the remote display the indication of electric current.

10. The method of claim 9, wherein the indication of the electric current is transferred to the remote display via a wireless protocol.

11. The method of claim 10, wherein the wireless transmission is IEEE 802.15.4.

12. The method of claim 9, wherein the wireless transmission occurs over an ad hoc mesh network.

13. A system for controlling and managing power delivery to an appliance, comprising:
a display including a touch surface;
a micro controller unit coupled to the display;
a transceiver coupled to the micro controller unit; and
a wireless ad hoc mesh network coupling the transceiver to a remote power interface.

14. The system of claim 13, wherein the micro controller unit includes a flash memory and an application program.

15. The system of claim 13, wherein the flash memory stores a unique serial number and a wireless network address.

16. The system of claim 13, wherein the application program comprises a network communication stack.

17. The system of claim 16, wherein the network communication stack is IEEE 802.15.4.

18. The system of claim 13, wherein the wireless ad hoc mesh network includes at least one IEEE 802.15.4n repeaters, at least on IEEE 802.15.4 endpoint, and at least one IEEE 802.15.4 coordinator.

19. The system of claim 18, wherein the IEEE 802.15.4 repeater and the IEEE 802.15.4 coordinator is a power interface.

20. The system of claim 13, wherein the display is a IEEE 802.15.4 endpoint.
